(19) United States
(12) Patent Application Publication
(10) Pub. No.: US 2008/0075861 A1
(43) Pub. Date: Mar. 27, 2008

(54) TIRE CLEANER AND PROTECTIVE COATING COMPOSITION

(76) Inventor: Lewyn B. BOLER JR., Stockton, CA (US)

Correspondence Address: SCHNADER HARRISON SEGAL & LEWIS, LLP, 1600 MARKET STREET, SUITE 3600, PHILADELPHIA, PA, 19103, US

(21) Appl. No.: 11/782,265

(22) Filed: Jul. 24, 2007

Related U.S. Application Data
(60) Provisional application No. 60/820,140, filed on Jul. 24, 2006.

(51) Int. Cl. C11D 3/37; B05D 3/00

(52) U.S. Cl. 427/322; 427/331; 510/189

(57) ABSTRACT

A composition of matter for application to a rubber surface comprises about 10 to 30 percent by weight of at least one glycol with a linear polymer compound of propylene oxide having two terminal hydroxyl groups and a molecular weight of about 4000 or greater; about 0.1 to 5 percent by weight of a water-soluble surfactant or detergent; and about 70 to 90 percent by weight of fast-evaporating solvent or a mixture of fast-evaporating solvents. The composition optionally may contain humectants, water, colorants, perfumes, leveling agents, dispersants, pigments, and other ingredients that are known in the art. The invention also includes a method of treating a rubber surface such as the surface of a tire, by applying a composition of matter according to the invention, with or without first washing the rubber surface.

This application claims priority to U.S. provisional application Ser. No. 60/820140, filed Jul. 24, 2006, which is hereby incorporated by reference.

### FIELD OF THE INVENTION

The present invention relates to a tire cleaner and protective coating composition for tires and other rubber items, as well as a method for treating rubber items and a method for treating automobile tires.

### BACKGROUND OF THE INVENTION

There are many compounds and methods for cleaning and protecting rubber items, especially vehicle tires. Most of these methods involve cleaning a rubber surface before applying a protective coating to it. It would be convenient to have a rubber-protecting compound that can be applied to a rubber surface without first cleaning the surface.

When vehicles are painted, it is desirable to apply a coating to the tires in order to prevent paint overspray from adhering to the tires. Many conventional tire coatings include compounds that can interfere with the painting process. As a result, when vehicle tires are to receive a protective coating before the vehicle is painted, care must be taken to keep the tire-coating composition away from the vehicle-painting process. It would be more convenient to have a tire-coating composition that would not interfere with the vehicle-painting process and that could even be applied in a vehicle-painting booth without adversely affecting the painting process. It would be convenient to have a tire-coating composition that may be discharged from a vehicle-painting booth's ventilation system and that will not interfere with the vehicle-painting process inside or outside of the vehicle-painting booth.

### SUMMARY OF THE INVENTION

Some embodiments of the applicant's invention provide one or more of the following advantages: a composition that can be applied to a clean or unclean tire surface and achieve good protective coating results; a composition that provides a lasting, flexible, high-gloss coating for tires and other rubber items; a composition that protects tires from paint overspray and that does not interfere with the vehicle-painting process; a composition whose components or vapors may be discharged from a vehicle-painting booth's ventilating system and that will not interfere with the vehicle-painting process inside or outside of the vehicle-painting booth; and a method for applying a protective coating to tires and other rubber items without first washing them.

This general description is not intended to limit the scope of the invention as claimed.

### DETAILED DESCRIPTION OF THE INVENTION

Applicant now describes embodiments of the claimed invention. The described embodiments are examples. This detailed description is not intended to limit the scope of the invention as claimed.

The composition is a liquid mixture in which a glycol and surfactant are dissolved or dispersed in a solvent. The composition comprises about 10 to 30 percent by weight of at least one glycol with a linear polymer compound of propylene oxide having two terminal hydroxyl groups and a molecular weight of about 4000 or greater—for example, the product Polyglycol P4000 listed in “The Polyglycol Handbook” published by the Dow Chemical Company in Midland Mich., 1988 Form No. 118-1026-889-AMS. The composition further comprises about 0.1 to 5 percent by weight of a water-soluble surfactant or detergent—for example, the product Calsuds CD-6 manufactured by Pilot Chemical Company in Santa Fe Springs Calif. The composition further comprises about 70 to 90 percent by weight of fast-evaporating solvent or a mixture of fast-evaporating solvents—for example, hexane, VM&P naptha, acetone, MEK, methyl acetate, or blends or equivalents thereof. The composition optionally may contain humectants, water, colorants, perfumes, leveling agents, dispersants, pigments, and other ingredients that are known in the art. In an illustrative embodiment, the solvent is acetone; the weight percentage of glycol is about 30 percent, the weight percentage of acetone is about 70 percent, and the weight percentage of surfactant is about 0.25 to 0.5 percent.

The glycol and the detergent are dissolved or dispersed in the solvent or solvents by simple mixing at ambient temperatures with a mixing blade or paddle in a steel, polyethylene, or appropriate vessel or tank. To make the composition, no pressure, heat, or other special processes are required. Due to the presence of the fast-evaporating solvents, safety measures used for handling solvents and combustible liquids should be used when mixing the composition.

The composition may be applied to a tire or other rubber item by spraying using a pump-action spray container or a compressor-driven sprayer, or by wiping the composition onto the tire, or by dipping the tire into the composition. The composition can be applied with aerosol or other sprayers. When the composition is applied to a tire under normal shop conditions, for example, atmospheric pressure and a temperature between 40° F. and 100° F., the solvent evaporates rapidly, minimizing dissolution of the tire compound and resulting messy runoff. The residue from the composition coats the tire. The composition can be used on many types of rubber parts other than tires to make them water-repellent so as to protect them from moisture and make them soil-resistant when stored for extended periods of time.

The composition can be applied to a clean or unclean tire surface and achieve good results with a good coating. The user can wash the tire with soap and water and then apply the composition by spraying, wiping, dipping, or other methods as described above. Or, surprisingly, the composition can be applied to an unclean vehicle tire surface and then rinsed with water at any point in time to remove soils. The composition will provide a lasting, flexible, high-gloss coating that will adhere to the tire surface in both methods.

What is claimed is:

1. A composition of matter for application to a rubber surface, the composition being a liquid mixture comprising:
about 10 to 30 percent by weight of at least one glycol with a linear polymer compound of propylene oxide having two terminal hydroxyl groups and a molecular weight of about 4000 or greater;
about 70 to 90 percent by weight of at least one fast evaporating solvent; and
about 0.1 to 5 percent by weight of a water soluble surfactant.

2. The composition of matter of claim 1 wherein the solvent comprises acetone.

3. The composition of claim 1 further comprising a detergent.

4. The composition of claim 1 wherein the surfactant is water-soluble.

5. The composition of claim 2 wherein the weight percentage of glycol is about 30 percent, the weight percentage of acetone is about 70 percent, and the weight percentage of surfactant is about 0.25 to 0.5 percent.

6. A method of applying a protective coating to a rubber surface, comprising the steps of:
applying to the rubber surface a composition of matter according to claim 1.

7. The method of claim 6, further comprising the step of, after applying the composition, rinsing the rubber surface with a solution containing about 95 percent or more by weight of water.

8. The method of claim 6, further comprising the step of, before applying the composition, washing the rubber surface with a soap and water.

9. The method of claim 6, wherein the rubber surface is a surface of a tire.

10. The method of claim 7, wherein the rubber surface is the surface of a tire.

11. The method of claim 8, wherein the rubber surface is the surface of a tire.
